(19) United States
(12) Patent Application Publication
(10) Pub. No.: US 2002/0184569 A1
(43) Pub. Date: Dec. 5, 2002

(54) System and method for using neural nets for analyzing micro-arrays

(76) Inventor: Michael O'Neill, Baltimore, MD (US)

Correspondence Address: SUGHRUE MION, PLLC, 2100 Pennsylvania Avenue, NW, Washington, DC, 20037-3213, US

(21) Appl. No.: 10/127,498

(22) Filed: Apr. 23, 2002

Related U.S. Application Data
(60) Provisional application No. 60/286,067, filed on Apr. 25, 2001.

(51) Int. Cl. H04L 1/22

(52) U.S. Cl. 714/39

(57) ABSTRACT

A computer based method for analyzing microarray chip information. A computer implemented artificial neural network (ANN) is trained by back propagation of error using a set of training microarray chip input vectors to create a trained ANN. At least one set of test data is applied to the trained ANN to generate a prediction. The trained ANN numerically analyzing with respect to a subset of the input vectors to identify those elements of the input vector which are most effective in obtaining the prediction. the set of input vectors is reduced in dimension to contain data only from those genes found most effective in obtaining the prediction to form a dimensionally reduced set of input vectors. The neural network is retrained using the dimensionally reduced set of input vectors by back propagation of error to generate a retrained network. The at least one set of test data is reapplied to the retrained neural network to generate a second prediction.

### I. DESCRIPTION

### I.A. RELATED APPLICATIONS

This Application claims priority from co-pending U.S. Provisional Application Serial No. 60/286,067 filed Apr. 25, 2001, which is incorporated in its entirety by reference.

### I.B. FIELD

This disclosure teaches techniques related to using neural nets for analyzing micro-array chips. Specifically, a technique involving differentiating the trained neural network is disclosed that produces improved accuracy.

### I.C. BACKGROUND

1. References

The following papers provide useful background information, for which they are incorporated herein by reference in their entirety, and are selectively referred to in the remainder of this disclosure by their accompanying reference codes in square brackets (i.e., <3>for the paper by O'Neill.):

<1> Alizedeh, A. A., et al. (2000). Distinct types of diffuse large B-cell lymphoma identified by gene expression profiling Nature 403:503-510, 2000.

<2> Werbos, P. J. (2000). The Roots of Backpropagation, John Wiley & Sons, New York.

<3> O'Neill, M. C. (1998). A general procedure for locating and analyzing protein-binding sequence motifs in nucleic acids. Proc. Natl. Acad. Sci. USA 95:10710-10715.

<4> Hastie, T., et al (2000). Gene shaving as a method for identifying distinct sets of genes with similar expression patterns. Genome Biology 1:research0003.

<5> Shipp, M. A., et al. (2002). Diffuse large B-cell lymphoma outcome prediction by gene-expression profiling and supervised machine learning. Nature Medicine 1:68-74.

<6> Alon, U., et al. (1999). Broad patterns of gene expression revealed by clustering analysis of tumor and normal colon tissues probed by oligonucleotide arrays. Proc. Natl. Acad. Sci. USA 96:6745-6750.

<7> Khan, J., et al (2001). Classification and diagnostic prediction of cancers using gene expression profiling and artificial neural networks. Nature Medicine 7:673-679.

<8> Perou, C. M., et al. (2000). Molecular portraits of human breast tumours. Nature 406:747-752.

<9> Dhanasekaran, S. M., et al. (2001). Delineation of prognostic biomarkers in prostate cancer. Nature 412:822-826.

2. Introduction

Cluster analysis is a well-known conventional technique for analyzing microarray data chips. In one implementation of the cluster analysis technique, Alizadeh et al. <1> performed a large scale, long-term study of diffuse large B-cell lymphoma (DLBCL), using microarray data chips. In this study, by doing cluster analysis on this data, they were able to diagnose 96 donors with an accuracy of 93% for this specific lymphoma. However, they were not able to predict which individual patients would survive to the end of the long-term study. Moreover, the International Prognostic Index for this disease was incorrect for 30% of these patients.

Cluster analysis has become established as a primary tool for the study of microarray data chips. However, this technique has not been particularly successful in identifying the core genes allowing the correct classification in the patterns under study.

In the preliminary step, clustering is an unsupervised mapping of the input data examples based on the overall pairwise similarity of those examples to each other. In this case, similarity is measured with respect to the expression levels of thousands of genes. Such a cluster analysis method is unsupervised in that no information of the desired outcome is provided. In subsequent cluster analysis steps, attempts are generally made to reduce the gene set to the subset of genes which are most informative for the problem at hand.

This subsequent step is a supervised step since there is an explicit effort to find correlations in the pattern of gene expression which match the classification one is attempting to make among the input examples. As this subselection is not routinely subjected to independent test using input examples originally withheld from the subselection process, it is generally not possible to judge how specifically the subselection choices relate to this specific set of examples as opposed to the general population of potential examples. To the extent that the gene set employed is much larger than the gene set which really determines the classification, it is possible that much of the clustering result will be based on irrelevant similarities.

Therefore it is desirable to have a more accurate analysis of microarracy chip data.

### II. SUMMARY

To realize the advantages and to overcome the disadvantages noted above, there is provided a computer based method for analyzing microarray chip information. A computer implemented artificial neural network (ANN) is trained by back propagation of error using a set of training microarray chip input vectors to create a trained ANN. At least one set of test data is applied to the trained ANN to generate a prediction. The trained ANN numerically analyzing with respect to a subset of the input vectors to identify those elements of the input vector which are most effective in obtaining the prediction. The set of input vectors is reduced in dimension to contain data only from those genes found most effective in obtaining the prediction to form a dimensionally reduced set of input vectors. The neural network is retrained using the dimensionally reduced set of input vectors by back propagation of error to generate a retrained network. The at least one set of test data is reapplied to the retrained neural network to generate a second prediction.

In another specific enhancement, the chip input vectors comprise data related to mRNA expression levels of a large number of specific genes.

In another specific enhancement, the chip input vectors comprise data related to proteins.

In another specific enhancement, the data array is created based on results of gas chromatography.

In another specific enhancement, the data array is created based on mass spectrometry data.

In another specific enhancement, the data array is created based on single or multidimensional gel analysis.

In another specific enhancement, the numerical analyzing is done using differentiation of the network.

In another specific enhancement, the microarray data represent positive or negative level of expression relative to a control state of a plurality of genes over a series of experiments.

In another specific enhancement, the microarray data correspond to data on malignant diffuse large B-cell (DLBCL).

In another specific enhancement, the microarray data correspond to data on breast cancer.

In another specific enhancement, the microarray data correspond to data on early prostate cancer and on metastatic prostate cancer.

In another specific enhancement the retrained network is used as a decoding program for results from new diagnostic or prognostic kits based solely on expression levels measured for an identified reduced set of genes.

Another aspect of the disclosed teachings is a computer system for analyzing microarray chip information comprising means for training a computer implemented artificial neural network (ANN) by back propagation of error using a set of training microarray chip input vectors to create a trained ANN; means for applying at least one set of test data to the trained ANN to generate a prediction; means for numerically analyzing the trained ANN with respect to specific test input vectors to identify those elements of the test input which are most effective in obtaining the prediction; means for retraining said neural network by back propagation of error on a dimensionally reduced set of input vectors that are most effective in obtaining the correct prediction to generate a retrained network; and means for applying at least one set of test data using the retrained neural network to generate a second prediction.

Yet another aspect of the disclosed teachings is a system for analyzing microchip array information comprising an input vector generator, an artificial neural network (ANN), a prediction generator and a numerical analyzer. The input vector generator is adapted to generate input vectors from microchip array information. The artificial neural network (ANN) is adapted to be trained by the input vectors as well as adapted to be retrained by a dimensionally reduced input vectors, corresponding to a reduced gene set. The prediction generator is adapted to apply at least one set of test data to the trained ANN to generate a prediction based on the ANN after it is trained by the input vectors and further adapted to apply at least one set of test data to the trained ANN to generate a second prediction based on the ANN after it is retrained by the reduced input set. The numerical analyzer is adapted to analyze the trained ANN with respect to specific test input vectors to identify those elements of the test input which are most effective in obtaining the prediction.

Still another aspect of the disclosed teachings is a computer program product including computer-readable media comprising instructions. The instructions are capable of enabling a computer to implement the methods described above.

### III. BRIEF DESCRIPTION OF THE DRAWINGS

The above advantages of the disclosed teachings will become more apparent by describing in detail preferred embodiments thereof with reference to the attached drawings in which:

FIG. 1 shows a block diagram of an implementation of the disclosed system.

FIG. 2 shows a flowchart depicting an implementation of the disclosed techniques.

FIGS. 3-9 show tables depicting data from the example implementations described herein.

### IV. DETAILED DESCRIPTION

IV.A. Synopisis

The disclosed techniques are based on artificial neural networks (ANN), a technique completely different from conventional cluster analysis. In an example scenario, using artificial neural networks (ANN), we were able to predict the long-term survival for each of the 40 DLBCL patients with no error, and we improved the diagnostic result to a single error in 96 donors. This improvement in information extraction is due to the advantages of ANN over conventional cluster analysis in microarray analysis.

While the conventional cluster analysis techniques are examples of unsupervised learning, back propagation ANNs are examples of supervised learning. During the training phase, the ANN are supplied with both the input data and the answer and are specifically tasked to make the classification of interest, given a training set of examples from all classes. That is, the ANN are constantly checking to see if they have gotten the ‘correct’ answer, the answer being the actual classification not just the overall similarity of inputs.

ANNs accomplish this by continually adjusting their internal weighted connections to reduce the observed error in matching input to output. When the ANN has achieved a solution which correctly identifies all training examples, the weights are fixed; it is then tested on input examples which were not part of the training set to see if the solution is a general one. It is only in this independent test that the quality of the ANN is judged.

The disclosed techniques are not limited to a single ANN. It is feasible to train a series of ANNs using, say, 90% of the examples for training and holding back 10% for testing. A different 10% can be tested in a second ANN and so on. In this way, with the training of ten ANNs, each input can be found in a test set one time and can, therefore, be independently evaluated. The data from example implementations of the disclosed teachings, presented below, with the exception of a few cases, are the output of ten slightly different trained ANNs, operating in test mode, which collectively evaluate the entire donor pool. This ‘round-robin’ procedure was employed, in duplicate, in every trial described throughout this work. The fact that one ends up with 10 ANNs is not an impediment to analysis since any future examples could be submitted to all 10 ANNs for evaluation, with a majority poll deciding the classification. These ANNs are, of course, likely to be very similar in that their training sets differ only slightly.

A second major advantage of ANNs follows from the first. Not only are ANNs trained to the specific question, rather than a loose derivative of that question, and tested for generality, but they can then be asked for a quantitative assessment of how they got the correct answer. Numerical partial differentiation of the ANN with respect to a given test input example <2,3> allows one to see the ANN's evaluation of the relative impact of each gene in arriving at the correct answer for this particular input. Cluster analysis has no corresponding highly-focused sight for targeting specific similarities as opposed to non-specific similarities. To the extent that this is true, ANNs should be able to identify relatively small gene subsets which will significantly outperform the initial gene sets in classification and which will also significantly outperform the gene subsets suggested by cluster analysis.

IV.B. Example Implementation

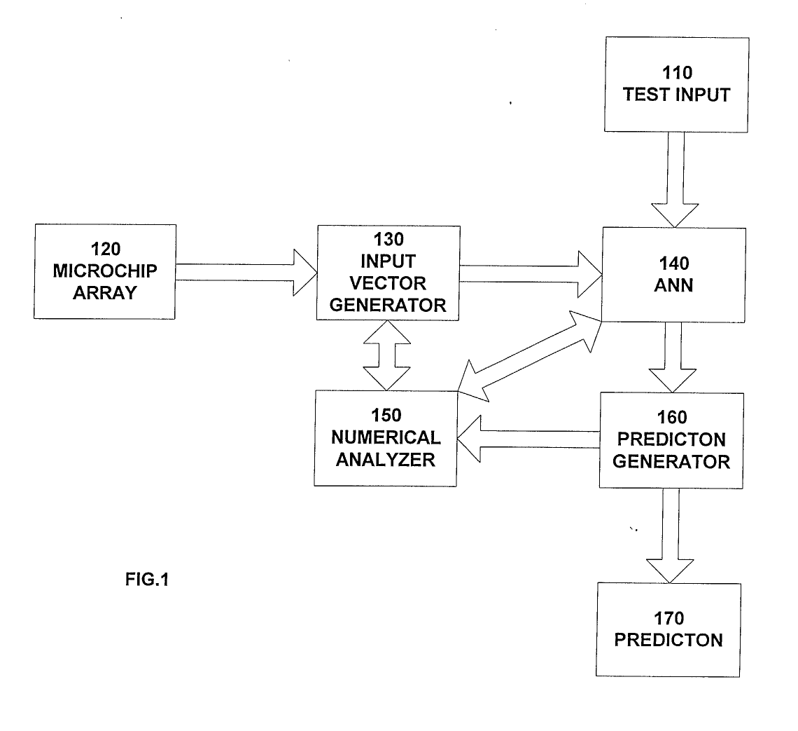

FIG. 1 shows an example implementation of the disclosed system. The data from microarray experiments 120 are stored in spreadsheet form. This data represent the positive or negative level of expression, relative to some control state, of 1000's of genes for two or more experimental conditions. An input vector generator 130, which is a short software program translates this data directly into a binary representation suitable as input vectors for an ANN 140. The ANN is trained on the corresponding data sets, with a fraction of the data, typically 10%, withheld for testing purposes. All open fields in the data array are set to zero. The test input 110 is provided to the ANN. The ANN then classifies new test data as to donor type. A prediction generator 160 receives the input from the ANN and provides a prediction 170.

Since the gene expression levels are read directly from the spreadsheet, their order and names are provided by the spreadsheet. Given the large amount of input data, these ANNs generally converge to a low error level very quickly during training, often in a minute or less. Subsequently additional ANNs are trained with a simplified input which contained only qualitative information in the form of a plus or minus sign to characterize the expression of each gene in the panel. This reduced the input size to 2 bits per gene, 01 for below the control and 10 for above, or equal to, the control. The output neuron was trained to output 1.0 for a positive donor and 0.0 for a negative donor in the diagnostic ANNS; for the prognostic ANNs 1.0 indicated a non-survivor and 0.0 a survivor. The 4026 gene panel ANN was provided, respectively, 100 or 67 middle-layer neurons for the 3 bit or 2 bit per gene inputs. With a very large number of input neurons it is possible to overload the middle-layer neurons, effectively always operating them at one extreme limit or the other; this can have the undesirable effect of reducing their sigmoid transfer function to a step function, with the loss of the ANN's non-linearity. This is clearly indicated if multiple output values are found to be exactly identical. ANNs were trained to an error level below 0.05 after which they were tested with previously unseen data. The ANNs trained on the reduced 34 or 19 gene sets had 6 or 4 middle-layer neuron.

To differentiate a trained ANN with respect to specific inputs, an ANN was trained on the 4026 gene panel with 2 bits per gene. The 5 positive donors from the test set were each differentiated at the numerical analyzer 150 using software which we designed for that purpose <2>. The selected genes were then compared among the 5 sets, with genes occurring in 3 or more instances being included in the final subset. This requirement generated a subset of 292 genes from the original 4026 genes. The ANNs 140 were retrained on this 292 gene subset and on two 146 gene subsets, representing every other gene from the 292 set. All were coded with 3 bits per gene and employed ANNs with 25 or 12 middle-layer neurons, respectively. Other ANNs were trained on the 292 gene set and the 146 ‘even’ set, coded with 2 bits per gene for subsequent differentiation.

The differentiation of the large panel ANNs trained for prognosis arbitrarily employed more selective criteria (see text) for subset determination with the result that a single differentiation reduced the gene set from 4026 genes to 34 genes. Subsequent ANNs demonstrated that this was a highly effective selection. After retraining, the test input was provided that provided a second prediction.

All ANNs in this study were three-layer back propagation ANNs trained with a learning coefficient of 0.3 and a momentum coefficient of 0.4 using the delta learning rule. The cutoff, in all cases, between positive and negative scoring was taken to be 0.5. No ANN required more than 4 minutes training time on a PC at 650 Mh; in the majority of cases, the ANN was fully trained in less than a minute. Training and testing a 10 ANN round-robin series could generally be done in less than 20 minutes. Training was deliberately kept to a minimum to avoid over-training. The ANNs represented here were in each case the first or second attempt result for the given problem.

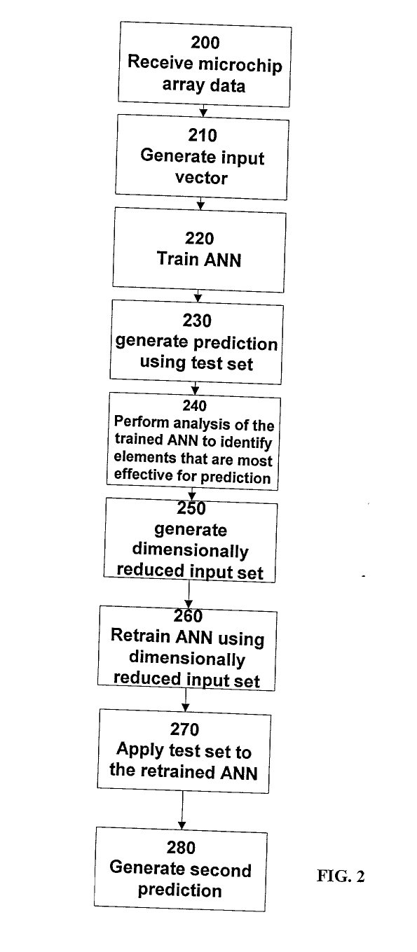

The methodology, in short, is represented by the flowchart shown in FIG. 2. Microarray chip data are received in step 200. In step 210, input vectors are generated for training the ANN. In step 220, the ANN is trained. In site 230 a prediction is generated using a test set. In step 240 the trained ANN is analysed to identify elements that were most effective in the prediction. In step 250, a dimensionally reduced input set is generated based on the analysis in step 240. The ANN is retrained in step 260 using the dimensionally reduced input set. In step 270 the test set is applied to the retrained ANN to generate a second, more accurate, prediction in step 280. As noted above, one way of performing numerical analysis on the trained ANN is by performing differentiation of the network.

It should be clear that the final trained network in the process serves as the decoding program for the results from future diagnostic/prognostic kits based solely on the expression levels measured for the reduced gene set identified by this process.

An aspect of the disclosed teachings is a computer program product including computer-readable media comprising instructions. The instructions are capable of enabling a computer to implement the methods described above. It should be noted that the computer-readable media could be any media from which a computer can receive instructions, including but not limited to hard disks, RAMs, ROMs, CDs, magnetic tape, internet downloads, carrier wave with signals, etc. Also instructions can be in any form including source code, object code, executable code, and in any language including higher level, assembly and machine languages.

The computer system is not limited to any type of computer. It could be implemented in a stand-alone machine or implemented in a distributed fashion, including over the internet.

### IV.C. Examples of Case Studies

1. Determining Patient Prognosis from Microarray data.

Cluster analysis <1,4> had shown that the 4026 gene expression panels for 40 DLBCL patients contained some information relevant to the question of prognosis but these authors did not make an attempt to provide survival predictions for individual patients.

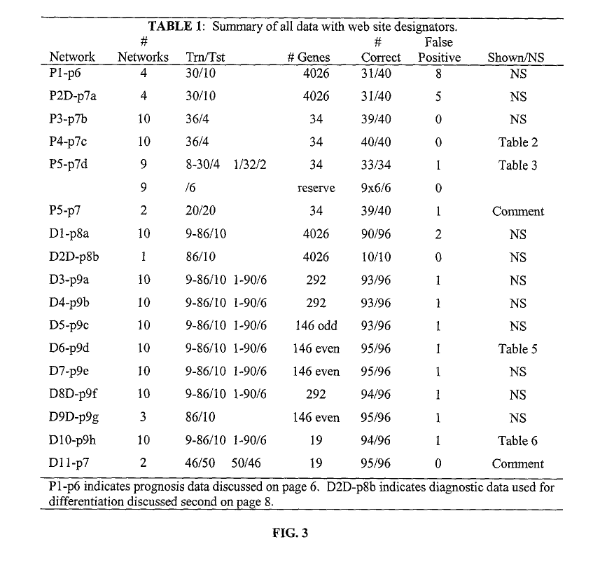

We wished to see if the ANN strategy, of train, test, differentiate, retrain on the reduced gene set, and retest, could produce any useful result with respect to prognosis on an individual basis. The approach would be: (1) use the entire gene set without preprocessing to train an ANN, testing to confirm that it had at least a good fit to the problem and, (2) use the ANN's definition of the problem, by differentiating the ANN, to focus on those genes most essential to the classification. These genes would then form the basis for training new ANNs with hopefully improved performance. Over 130 ANNs were trained for this study. Table 1 (shown in FIG. 3) provides a summary overview of the data, including data not shown.

Initially an ANN was trained to accept microarray data on the complete panel of 4026 genes from 40 patients. This ANN had 12078 input neurons with a semi-quantitative assessment of each gene, 100 middle-layer neurons, and a single output neuron. The ANNs were originally designed with 3 input bits per datum: one for sign,‘-’=1, and 2 for quantitative degree of signal with 00 being 0 to 0.5, 01 being >0.5 to 1.0, 10 being >1.0 to 2.0, and 11 being >2.0. Thus ‘011’ would indicate a particular gene whose expression, relative to control, was increased at a magnitude >2. The training set included 30 donors, with 10 additional donors being held back as test data. The ANN was trained by processing 12 iterations of the complete training set. The test set, drawn from a mixture of survivors and non-survivors, was then run. The entire process was then repeated with a different choice of test data each time. In this round-robin fashion, all donors serve as test data for one of the ANNs, and each training set is necessarily slightly different.

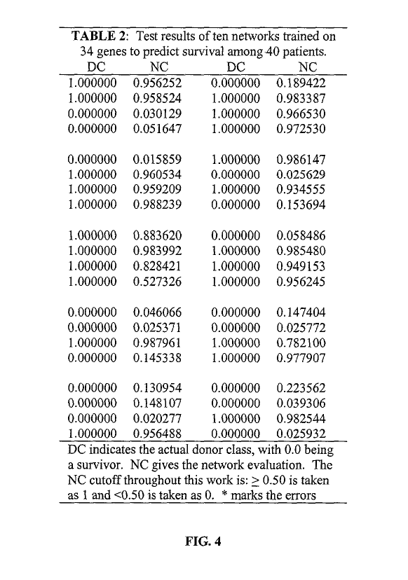

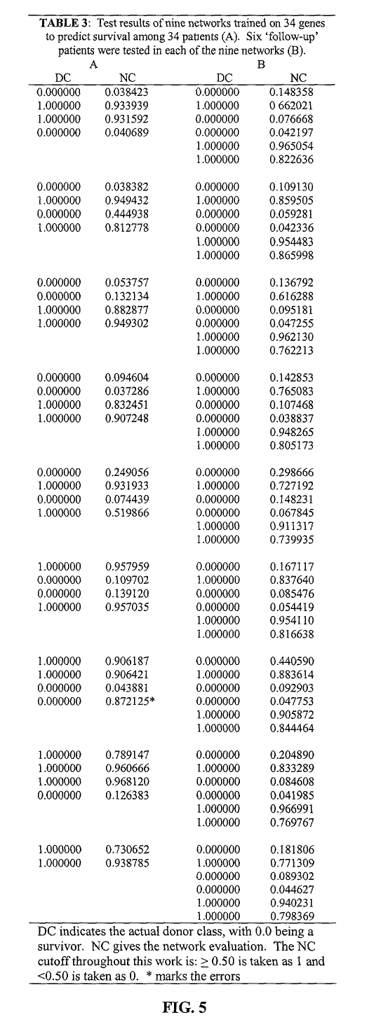

A round robin series of 4 ANNs was generated. Data underlying FIG. 5 of the report in http://llmpp.nih.gov/lymphoma/data.shtml were used for training. The ANNs were asked to predict, based on the 4026 gene set, which of 40 DLBCL patients would survive to the end of the study (longest point=10.8 yrs). ANNs initially varied with from 1 to 3 errors on 10 test patients each, for a total of 31 of 40 patients correctly predicted (data not shown). However, a trained ANN can be numerically differentiated <2,3> to show the relative dependence of the output (classification) on each active input neuron within an input vector. Briefly stated, the differentiation process involves slightly perturbing the activation (down from 1.0 to 0.85) of each active input neuron, one at a time, to note the specific change in the output value. We then trained qualitative ANNs, with 2 bits per gene, on the 4026 gene set in order to differentiate them (‘1 0’ for expression greater than, or equal to, the control, ‘0 1’ for less than the control). The ANNs had 67 middle layer neurons. This coding has the effect that there is an active neuron for each gene in the set regardless of expression level and the total number of active input neurons is constant from input to input. By taking the top 25% of genes in each of 12 differentiations and requiring agreement of at least 4 of 12 patients in choosing each gene, we obtained a set of 34 genes. (These cutoff criteria are necessarily arbitrary and are only justified by subsequent proof that they produced gene subsets having the desired information.) A round-robin series of 10 ANNs, with 4 test donors each, produced a single error (DLCL0018) in survival predictions when trained on these 34 genes (data not shown). The second round-robin training with the same gene set produced no errors, correctly evaluating all 40 patients in a series of 10 test sets (Table 2, shown in FIG. 4).

Would it be better to have larger test sets? Would training on half the patients and testing on the other half prove a robustness or superior generalization beyond what can be seen in the 10 tests of 10% each? For cross-validation, one would have 2 ANNs, the second reversing the training and testing halves of the first. Suppose the pair produces 1 error. The set of 2 has in no way outperformed the set of 10, each yields 1 error and this 1 error is the collective test of generalization. All that has been shown is that, for this particular makeup of group A and group B in the 2 ANN case, less training data are required to obtain an equivalent result to the 10 ANN case. Which set is likely to do better in the classification of follow-up data? The 10 ANN set is. Each member of the 10 ANN set has had the advantage of a larger training set than either member of the 2 ANN set; each member of the 10 ANN set is also less likely to run afoul of the partitioning specifics characterizing the 2 ANN set.

For a second study, we took 6 patients at random, 3 from each class, and held them in reserve to model information from a A follow-up study. Nine ANNs were trained, on the 34 gene set, using the remaining 34 patients; 8 had 30 patients in the training set and 4 in the test set; the 9^{th} had 32 patients in the training set and 2 in the test set. Collectively, these ANNs made a single error in the prognosis of 34 patients (Table 3, shown in FIG. 5). The data for the 6 reserve patients were then tested on all 9 trained ANNs to emulate follow-up data. Each of the 6 patients was correctly classified by each of the 9 ANNs.

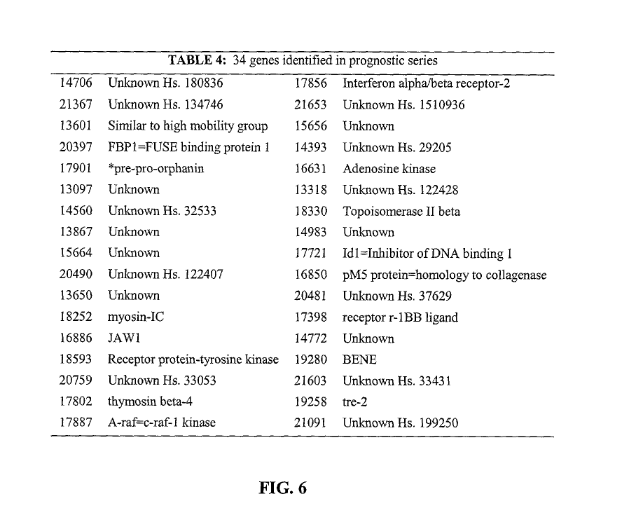

The 34 genes are given in Table 4, shown in FIG. 6. In 5 of 12 cases, the gene chosen as most influential in determining the correct prognosis was 18593, a tyrosine kinase receptor gene. While this gene set may not be the absolute best possible, it clearly does contain sufficient information for error-free predictions on these patients. The identification of this gene set will hopefully lead eventually to a better understanding of the interaction of these genes in this disease as a result of future studies.

2. Diagnosing lymphoma from microarray data.

The diagnosis of DLBCL lymphoma by biopsy is not trivial. Even with gene expression data, clustering techniques produced a misreading of 7 out of 96 donors <1>, a result unimproved in their hands by further analysis of reduced gene panels. We wished to see if back propagation neural ANNs could do better using the same data set. This testing over the whole donor set with 4026 genes produced 6 errors in diagnosis (data not shown).

Thus, in the first round, ANN merely match cluster analysis. In preparation for differentiation, an ANN was trained with the same donor sets as the first ANN above, but coded qualitatively. This ANN correctly classified the 10 members of the test set (data not shown). The 5 positive donors from the test set were each used, in turn, to differentiate the ANN. In these cases, the first criterion for selection was broad: the gene had to contribute at least 10% as much as the gene making the maximum contribution to the correct classification; the second criterion was that 3 or more of the donors had to agree on the selection. This produced a subset of 292 genes. The number of genes referenced by a given donor under identical criteria ranged from 45 to 1448. Only 38% of the genes overlapped the 670 gene subset identified by cluster analysis. It was of interest to see if these genes were sufficient for correct classification of the donors. Ten different ANNs were trained with the 292 gene subset. Three (OCI Ly1 and DLBCL0009 and tonsil) errors were produced over 96 donors in 2 separate series (data not shown).

At this point, the ANNs were doing a much-improved diagnosis; it remained to be seen if the gene set could be further refined. The set of 292 genes was then treated in two different ways: (1) it was arbitrarily split into even and odd halves, with each half being used to train ten new ANNs. (2) it was used whole to train ten qualitative ANNs for further differentiation.

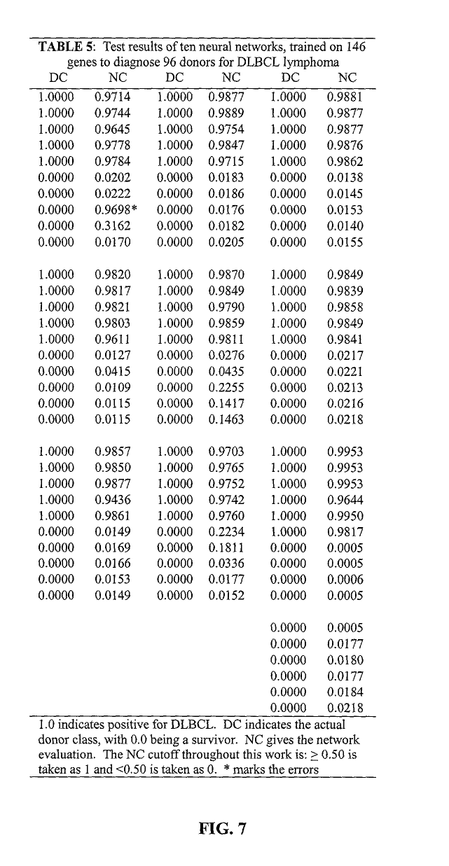

Twenty different ANNs were then trained using a 146 gene (odd or even numbered) subset of the 292 gene set in 2 series of 10. The odd set again produced 3 errors (data not shown). In the even set, a single error was made over 96 donors in ten different test sets, identifying the ‘tonsil’ inlier in the earlier cluster analysis (1) as positive (Table 5, shown in FIG. 7). Ten additional ANNs were trained on the even set with the same result (data not shown).

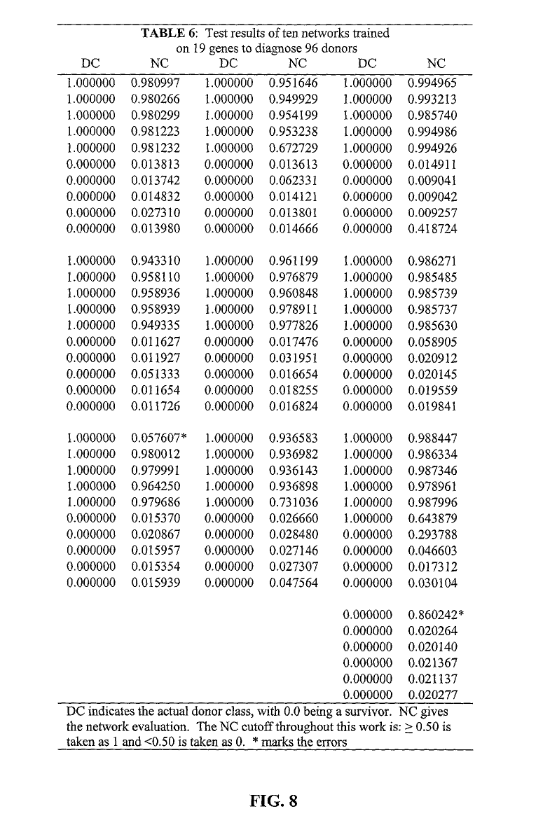

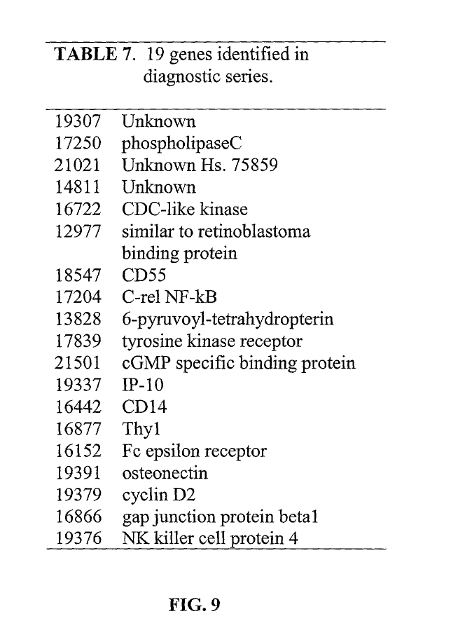

The differentiation of the ANNs from the 292 gene set pointed to 8 genes. Given the high accuracy of the even 146 gene set, we also trained ANNs on this set for differentiation. These pointed to 11 additional genes. In these cases, only genes in the top 20% in influence and shared by at least 25% of the differentiated examples were considered. ANNs trained on these 19 genes produced 2 errors over 96 donors in 10 test sets (Table 6, shown in FIG. 8). The 19 genes, using the designation from the initial report, are given in Table 7, shown in FIG. 9.

3. Estrogen dependence of breast cancer

Another diagnostic test was performed using data found in Nature, vol.406, p747,2000. The data related to Estrogen dependence of breast cancer tumors for tumor staging. ANN analysis of this microarray data produced a reduced gene set of 14 genes: arylamine-N-acetyltransferase, estrogen receptor-1, LIV-1 protein, BMI-1 oncogene homolog, lysophospholipase, cytochromeoxidase C subunit VIC, matrix metalloproteinase 14, keratin 17, 2 Est similar to keratin K5, 2 clones of cadherin 3, 2 clones of human rearranged immunoglobulin lambda light chain.

Networks trained on the expression levels of only these 14 genes were able to make a perfect classification between hormone-dependent and hormone-independent tumors on 62 tissue samples from 42 patients.

4.5-yr Survival from human breast cancer

The data for this study came from Nature, vol. 415, p530 2002, related to prediction of 5-yr. survival from microarray data from human breast cancer patients. ANN analysis of this data produced a reduced gene set of 28 genes: 31155_RC, protein similar p54 nrb, Est protein similar human Grb 2, Est RNA binding protein 4, ser-thr protein kinase, aldehyde dehydrogenase 4, matrix metalloprotein 24, Hs AF001435, kalikrein 2, Est DKFZp564H092, zinc finger protein 255, apolipoprotein B mRNA editing protein, protein similar to rat protein phosphatase -1, DKFZP564p1816, Hs24694, DKFZP434n161, Est L2DLT protein, protein similar testes specific Y encoded protein, no information #17583, protein similar to helicase, PLJ10933, insulin, DKF2P566M043, FLJ13114.

Networks trained on this reduced gene set produced only 2 errors in evaluating the 5 yr. survival of 78 patients.

5. Tri-state cancer study

The data for this study came from Nature vol, 412 p822 2001 related to diagnostic data from microarrays on 53 patients representing cancer-free controls, early prostate cancer, and metastatic prostate cancer.

ANN analysis of patients based on separate thirds of the total gene pool produced the following three mutually-exclusive reduced gene sets. Each of these sets was capable of error free three-way diagnosis of 45 patients (8 patients held back as follow-up data). They produced 1 error, 1 error, and 2 errors respectively on the 8 follow-up cases.

a) Set 1 36 genes

zinc finger protein KIAA0222 *, unknown #235 *, murine osteosarcoma viral oncogene homolog *, SNRPC, L13, archain 1, SCA1 ataxin 1, BO4 erythrocyte membrane protein, Est #256 6, ACTG2 actin gamma 2 *, Est #3175 *, SON DNA binding protein, MBNL muscle-blind protein *, Est #4267, integrin alpha 2, PEA 15 astrocyte phosphoprotein, SELE selectin E, Est #6280, Unknown #6420, Tyrosine phosphatase IV A, SCYA2 cytokine A2, FLJ 20767*, CTSB cathepsin B, MEIS 2 *, PEX12, ST5 suppressor of tumorigenicity 5, EGR-1, SURB7 suppressor of RNA polymerase B *, similar aminotransferase *, ST13 suppressor of tumorigenicity 13, SLAP sarcolemma assoc. protein, OR7E47p olfactory receptor 7E, GPM6B glycoprotein, CD69 T cell activation antigen, ODC1 ornithine decarboxylase 1 *,SCYA2 cytokine A2.

b) Set 2 45 genes

GBP2 *, STPBN1 beta-spectrin, FLJ11712, KIAA1200 *, ITSN1 ,intersectin 1, PPP2CB protein phosphatase, unknown #911, FLJ20898, CREB Rubenstein-Taybri Syndrome, N-acetyl glucosamine transferase, DKF2P, PFDN5 prefoldin, EEF2 translation elongation factor 2, TNRC3 trinucleotide repeat *, LAMA 4 laminin 4 *, GSTM5 glutathione-S-transferase, FLJ10607 *, MBL-2 mannose binding lectin, FLJ20580, DTN, pleiotrophin, CAV 2 caveolin 2, unknown #4325, SNAP23 synaptosomal, assoc. protein, FLJ22300 *, inositol-polyphosphate-5-phosphatase, TPP52 tumor protein 52,SSR3 signal sequence receptor, FLJ14153, EXTL-1 exotosis-like 1, LUM lumican, KLF4 Kruppel-like skin barrier protein *, HYPE Huntingtin interating protein,I TIH1 inter alpha globulin inhibitor *, Unknown #7769, B1 andregenic receptor, HPS Hermansky-Pudlak Syndrome *, Unknown #8615, EGF response factor 1 *, MCF2 transforming sequence, DBOST glucosyltransferase *, S11 ribosomal protein, CPM6B M6B, FLJ23322, Unknown #9815 *, TRPC1 receptor potential channel

c) Set 3 18 genes

TIMP3 inhibitor of metalloproteinase, MEG3 *, KCNA2 K voltage gated channel *, FLJ122004, kinesin *, MYRL2 myosin regulatory |t chain, CXADR, receptor coxsackie adenovirus, KIAA1181 *, EDNRA endothelin receptor A, CRABP1 retinoic acid binding protein, similar to modulator recognition factor, 2XPA exoderma pigmentosum, Unknown #8415 *, Unkown#8619, MEIS1 *, ARGBP2, KIAA 0997, PGAT diacylglycerol-o-acyltransferase

The highest rated genes from the 3 groups above were combined into a new group of 34 genes spanning the entire initial gene collection. Combined set 34 genes : All in above 3 sets followed by ‘*’ plus ser-thr kinase, EMP70 endoembrane protein, phosphatidic acid phosphatase, RAB39.

ANN trained on only these 34 genes made 0 test errors in 45 patients and 0 follow-up error over 8 follow-up patients for the best overall performance in prostate diagnosis.

A final study with the prostate data was done to test the level of redundancy in the information provided within the microarray. We picked every 25^{th} gene from the gene list for a total of 399 genes. We trained networks on just these genes. These network made 5 errors over 44 patients and 5 errors over 8 follow-up patients. Differentiation led to the selection of 21 genes. New networks trained on just these 21 genes made 1 error over 44 patients and no errors on the 8 follow-up patients.

d) Random set 21 genes

Unknown #250, FOXO1A forkhead box, SALL 2 sal-like, OGT O-linked N-acetylglucosamine transferase, CAMKK2 Ca dependent protein kinase, Unknown #2500, LAMA 4 lamanin, HRB2 HIV1 reverse binding protein 2, MBNL muscle blind protein, Unknown #4325, SNAP23, INPP5A inositol polyphosphate-5-phosphatase, RPL21 ribosomal protein L21, AP15L1 AP15 like, Unknown #6050, similar modulator protein see above, Unknown #6475, FM05 flavin monooxigenase 5, ST14 suppressor of tumorigenicity 14, Unknown #9725.

IV.D. Discussion

The rather remarkable conclusion of this analysis is that there is sufficient information in a single gene expression time point of less than 5 dozen genes, in the lymphoma case for example, to provide perfect prognosis (out to ten years) and near-perfect diagnosis for this set of donors. Furthermore, ANNs, through a strategy of train and differentiate, bring that information to the fore by progressively focusing on the genes within the larger set which are most responsible for the correct classifications, providing at once a reduction in the noise level and specific donor profiles. This focus on the specific classification problem led to a set of 34 genes for prognosis and a second set of 19 genes for diagnosis. These sets are mutually exclusive. The gene subsets suggested by cluster analysis <1> are not supersets of these sets; the 670 gene set of the initial report captured only 7 of the 19 gene set used for diagnosis and the 148 gene staging set captured only 2 of the 34 gene set used for prognosis. The 234 gene subset proposed by Hastie, et al. <4> for prognosis contains 6 of the 34 gene set. There was no overlap with the 13 gene set identified by Ship, et al <5> to correlate with their cured/fatal classes for this disease. At first, it might seem surprising that the gene subsets identified here do not appear to be subsets of those identified earlier by Alizadeh et al. But this surprise is based on a naive intuition. The fact is that we do not know the level of information redundancy which exists in these large arrays. Apropos of this point, Alon et al. <6> discarded the 1500 genes indicated by cluster analysis as most discriminatory in their study of colon cancer and, upon reclustering, found their diagnosis unimpaired. Likewise, it may be that while the top 10% of relevant genes might be sufficient for perfect classification, so might the next 10%. These sets by definition are mutually exclusive. By extension, it is not difficult to believe that some other large gene set might be able to get 75% of the classifications correct with little or no overlap with those genes in the top 10%.

The identification of specific genes associated with a particular biological characteristic such as malignant phenotype would be useful in many settings, (1) Precise classification and staging of tumors is critical for the selection of the appropriate therapy. At present, classification is accomplished by morphologic, immunohistochemical, and limited biological analyses. Neural net analysis in the form of specific donor profiles could provide a fine structure analysis of tumors characterizing them by a precise weighting of the genes, which they express differentially. Neural net profiling may identify gene panels, which are tumor or stage specific. While this manuscript was in preparation, there was a report by Khan, et al <7> of an ANN analysis producing a perfect diagnosis of four difficult tumor types. (2) At present, only subsets of patients with a given type of tumor respond to therapy. ANNs trained to distinguish responders from non-responders would allow a comparison of tumor-expressed genes in responders and nonresponders to find those genes most predictive of response. As noted above, we have used ANNs on the data of Perou et al. <8> for classifying breast tumors as hormonally responsive or nonresponsive. ANNs which gave a perfect classification with 496 genes pointed to a subset of 12 genes. Retraining on these 12 genes produced no error in classifying 62 tissue samples from their study (unpublished data). As also noted, we have analyzed the data of Dhanasekaran, et al on prostate cancer <9>. Here the original set of 9984 genes was reduced to 34 genes. Retraining on these 34 genes gave no errors in a 3-way (normal, early tumor, metastatic disease) classification of 53 patients (unpublished data). Given the significant impairment in the quality of life for many patients undergoing chemotherapy and/or radiation therapy, such prospective information would be extremely beneficial. (3) T cell and antibody-mediated immunotherapy may be efficacious approaches for limiting tumor growth in cancer patients. At present there is a paucity of known tumor rejection antigens that can be targeted. Neural net analysis may identify a panel of tumor-encoded genes shared by many patients with the same type of cancer and thereby provide a repertoire of potentially novel tumor rejection antigens. (4) For many patients with autoimmune disease the target antigen(s) is unknown. Enhanced identification of cell-type specific markers of the target organ through neural net profiling could identify potential target antigens as candidate molecules for testing and tolerance induction.

We believe ANNs will be an ideal tool to assimilate the vast amount of information contained in microarrays. The artificial networks presented here were not selected from a large number of attempts. The ANNs described here are the first or second attempts with the data and format stated; the longest training session lasted less than 5 minutes. Indeed, the trained ANN may, in the form of its weight matrix, have the best possible “understanding” of the very broad statement being made in the microarray, a view that is accessible with the differentiation of the ANN. In this study, that viewpoint suggested a small subset of genes, which proved sufficient to give a near-perfect classification in each of two problems. This approach should be suitable for any microarray study, which contains sufficient training data.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A computer based method for analyzing microarray chip information comprising:
training a computer implemented artificial neural network (ANN) by back propagation of error using a set of training microarray chip input vectors to create a trained ANN;
applying at least one set of test data to the trained ANN to generate a prediction;
numerically analyzing the trained ANN with respect to a subset of the input vectors to identify those elements of the input vector which are most effective in obtaining the prediction;
reducing the set of input vectors in dimension to contain data only from those genes found most effective in obtaining the prediction to form a dimensionally reduced set of input vectors;
retraining said neural network using the dimensionally reduced set of input vectors by back propagation of error to generate a retrained network; and
applying the at least one set of test data using the retrained neural network to generate a second prediction.

2. The method of claim 1, wherein the chip input vectors comprise data related to mRNA expression levels of a large number of specific genes.

3. The method of claim 1, wherein the chip input vectors comprise data related to proteins.

4. The method of claim 1, wherein the data array is created based on results of gas chromatography.

5. The method of claim 1, wherein the data array is created based on mass spectrometry data.

6. The method of claim 1, wherein the data array is created based on single or multidimensional gel analysis.

7. The method of claim 1, wherein the numerical analyzing is done using differentiation of the network.

8. The method of claim 1, wherein the microarray data represent positive or negative level of expression relative to a control state of a plurality of genes over a series of experiments.

9. The method of claim 1, wherein the nicroarray data correspond to data on malignant diffuse large B-cell (DLBCL).

10. The method of claim 1, wherein the microarray data correspond to data on breast cancer.

11. The method of claim 1, wherein the microarray data correspond to data on early prostate cancer and on metastatic prostate cancer.

12. A computer system for analyzing microarray chip information comprising:
means for training a computer implemented artificial neural network (ANN) by back propagation of error using a set of training microarray chip input vectors to create a trained ANN;
means for applying at least one set of test data to the trained ANN to generate a prediction;
means for numerically analyzing the trained ANN with respect to specific test input vectors to identify those elements of the test input which are most effective in obtaining the prediction;
means for retraining said neural network by back propagation of error on a dimensionally reduced set of input vectors that are most effective in obtaining the correct prediction to generate a retrained network; and
means for applying at least one set of test data using the retrained neural network to generate a second prediction.

13. The system of claim 12, wherein the chip input vectors comprise data related to mRNA expression levels.

14. The system of claim 12, wherein the chip input vectors comprise data related to proteins.

15. The system of claim 12, wherein the data array is created based on results of gas chromatography.

16. The system of claim 12, wherein the data array is created based on mass spectrometry data.

17. The system of claim 12, wherein the data array is created based on single or multidimensional gel analysis.

18. The system of claim 12, wherein the means numerical analyzing uses performs the analyzing using differentiation of the ANN.

19. The system of claim 12, wherein the microarray data represents positive or negative level of expression relative to a control state of a plurality of genes over a series of experiments.

20. The system of claim 12, wherein the microarray data corresponds to data on malignant diffuse large B-cell (DLBCL).

21. The system of claim 12, wherein the microarray data corresponds to data on breast cancer.

22. The system of claim 12, wherein the microarray data correspond to data on early prostate cancer or metastatic prostate cancer.

23. A system for analyzing microchip array information comprising:
an input vector generator adapted to generate input vectors from microchip array information;
an artificial neural network (ANN) adapted to be trained by the input vectors as well as adapted to be retrained by a dimensionally reduced input vectors, corresponding to a reduced gene set;
a prediction generator adapted to apply at least one set of test data to the trained ANN to generate a prediction based on the ANN after it is trained by the input vectors and further adapted to apply at least one set of test data to the trained ANN to generate a second prediction based on the ANN after it is retrained by the reduced input set; and
a numerical analyzer adapted to analyze the trained ANN with respect to specific test input vectors to identify those elements of the test input which are most effective in obtaining the prediction.

24. The system of claim 23, wherein the chip input vectors comprise data related mRNA expression levels.

25. The system of claim 23, wherein the chip input vectors comprise data related to proteins.

26. The system of claim 23, wherein the data array is created based on results of gas chromatography.

27. The system of claim 23, wherein the data array is created based on mass spectrometry data.

28. The system of claim 23, wherein the data array is created based on single or multidimensional gel analysis.

29. The system of claim 23, wherein numerical analyzier is adapted to perform the analyzing using differentiation of the ANN.

30. The system of claim 23, wherein the microarray data represents positive or negative level of expression relative to a control state of a plurality of genes over a series of experiments.

31. The system of claim 23, wherein the microarray data correspond to data on malignant diffuse large B-cell (DLBCL).

32. The system of claim 23, wherein the microarray data correspond to data on breast cancer.

33. The system of claim 23, wherein the microarray data correspond to data on early prostate cancer or on malignant prostate cancer.

34. A computer program product, including computer-readable media, said media comprising instructions to enable a computer to perform a procedure comprising:
training a computer implemented artificial neural network (ANN) by back propagation of error using a set of training microarray chip input vectors to create a trained ANN;
applying at least one set of test data to the trained ANN to generate a prediction;
numerically analyzing the trained ANN with respect to a subset of the input vectors to identify those elements of the input vector which are most effective in obtaining the prediction;
reducing the set of input vectors in dimension to contain data only from those genes found most effective in obtaining the prediction to form a dimensionally reduced set of input vectors;
retraining said neural network using the dimensionally reduced set of input vectors by back propagation of error to generate a retrained network; and
applying the at least one set of test data using the retrained neural network to generate a second prediction.

35. The computer program product of claim 34, wherein the chip input vectors comprise data related mRNA expression levels.

36. The computer program product of claim 34, wherein the chip input vectors comprise data related to proteins.

37. The computer program product of claim 34, wherein the data array is created based on results of gas chromatography.

38. The computer program product of claim 34, wherein the data array is created based on mass spectrometry data.

39. The computer program product of claim 34, wherein the data array is created based on single or multidimentional gel analysis.

40. The computer program product of claim 34, wherein the numerical analyzing is done using differentiation of the network.

41. The computer program product of claim 34, wherein the microarray data represent positive or negative level of expression relative to a control state of a plurality of genes over a series of experiments.

42. The computer program product of claim 34, wherein the microarray data correspond to data on malignant diffuse large B-cell (DLBCL).

43. The computer program product of claim 34, wherein the microarray data correspond to data on breast cancer.

44. The computer program product of claim 34, wherein the microarray data correspond to data on early prostate cancer or metastatic prostate cancer.

45. The method of claim 1 further comprising:
using the retrained network as a decoding program for results from new diagnostic or prognostic kits based solely on expression levels measured for an identified reduced set of genes.

46. The system of claim 12 wherein the system is adapted to use the retrained network as a decoding program for results from new diagnostic or prognostic kits based solely on expression levels measured for an identified reduced set of genes.

47. The system of claim 23 wherein the system is adapted to use the retrained network as a decoding program for results from new diagnostic or prognostic kits based solely on expression levels measured for an identified reduced set of genes.

48. The computer program product of claim 34 wherein the instructions further comprise:
using the retrained network as a decoding program for results from new diagnostic or prognostic kits based solely on expression levels measured for an identified reduced set of genes.
